(19) United States
(12) Patent Application Publication
(10) Pub. No.: US 2009/0161001 A1
(43) Pub. Date: Jun. 25, 2009

(54) Camera and method for operating same

(76) Inventor: Juergen Eisen, Augsburg (DE)

Correspondence Address: EPSTEIN DRANGEL BAZERMAN & JAMES, LLP, 60 EAST 42ND STREET, SUITE 820, NEW YORK, NY, 10165, US

(21) Appl. No.: 12/069,283

(22) Filed: Feb. 8, 2008

(30) Foreign Application Priority Data
Feb. 8, 2007 (EP) 07002765.1

(51) Int. Cl. H04N 5/225

(52) U.S. Cl. 348/360

(57) ABSTRACT

A camera (1) comprises photoelectric converters (6), which convert incident light with transfer functions into electrical signals. In order to be able to use this camera (1) also for measuring purposes, the camera (1) comprises at least one diffuse light source (10), which can apply this light on least a part of the photoelectric converters (6). The photoelectric converters (6) have an active connection with a data processor (12) which calculates at least one characteristic property of the transfer function of the photoelectric converters (6) obtained from the electrical signals. In this manner, differences in the transfer functions can be compensated and the electrical signals can thus be used for measuring purposes.

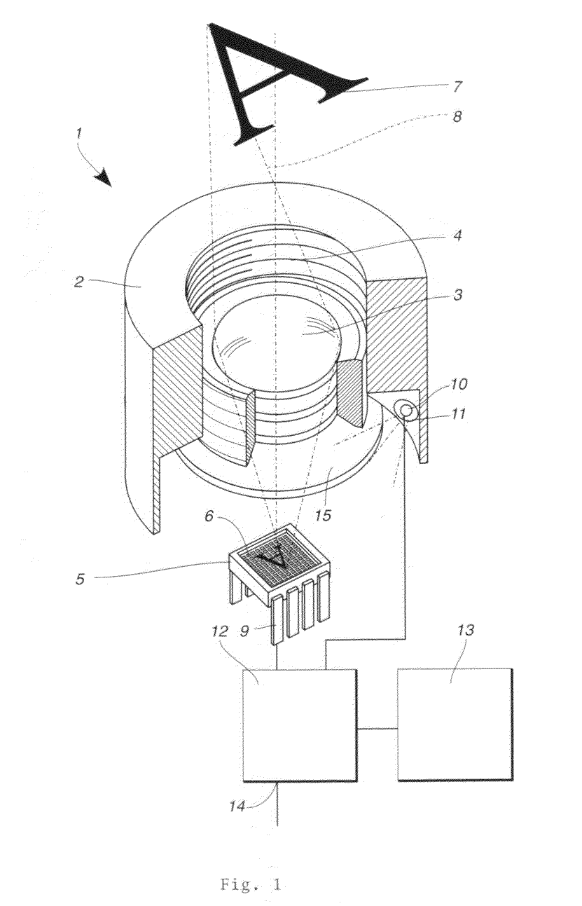

DE 10 2004 048 914 B1 discloses a camera, which comprises a camera lens and a CCD chip. The CCD chip has a series of photodiodes, which convert incident light into voltage. These electrical signals are serial output from the CCD chip in load cycles. This camera has particularly proven itself for optical detection of running web materials and has constituted the starting point for the present invention.

The object of the invention is to create a camera as well as a method of operation for this camera, which are distinguished by improved measuring accuracy of the incident luminance.

The invention teaches that this object is solved with the process steps of claim 1 as well as with the features of claim 7.

The method as taught by the invention is used for operating a camera with photoelectric converters.

The photoelectric converters are preferably comprised of photodiodes or phototransistors, whereby the subject matter of the invention is not limited hereto. Important is merely that the photoelectric converters must be capable of converting incident light into electrical signals. In this instance, each photoelectric converter has its own unique transfer function, so that the distribution of the received luminance cannot be directly inferred from the distribution of the electrical signals across the individual photoelectric converters. It has been shown that a typical inaccuracy of approximately +/−5% exists in the proportionality factor of this transfer function from converter to converter. This inaccuracy is generally not acceptable in metrological applications, if it involves the capturing of low contrast structures securely, for example. For this purpose, diffuse light is applied at least partially to the photoelectric converters, whereby preferably all photoelectric converters are approximately illuminated equally. In this instance, the characteristic properties of the transfer function of the individual photoelectric converters are not only a part of the imaging behavior but also part of the behavior in relation to the additional diffuse light. Therefore, using appropriate arithmetic functions from the electrical signals with and without diffuse illumination, at least one characteristic property of the transfer function of the photoelectric converters can be calculated. With the help of this information, the actual camera image photographed can then be appropriately corrected. In this instance, the correction itself must not necessarily be done inside the camera.

In particular, it was also considered to output only the raw image data together with the characteristic properties of the photoelectric converters obtained, in order to reduce the required computing capacity inside the camera, so that subsequent applications are at least capable of correcting these raw data, if necessary.

One characteristic property of the transfer function which can be determined in this manner, to be particularly considered, is a sensitivity, a dark signal and/or a color dependency of the individual photoelectric converters. The most important factor in this process is the sensitivity, i.e. the proportionality factor between the incident luminance in the measured solid angle and the voltage value that is output. As experience teaches, the sensitivity varies most between individual converters and is therefore of primary importance. In addition, a dark signal can also be determined by selecting two different luminances of the diffuse light, for example. In this manner, multiple points of the transfer function can be obtained, so that apart from the sensitivity, also the dark signal can be determined. If a broad-band light source and/or at least a heterochromatic light source is used as diffuse light source, also the color dependency of the individual photoelectric converters can be determined in this manner. This is obviously only sensible with cameras which are suitable for color and permit vectorial color determination. In this manner, automatic white balancing can be done.

In order to determine image data from the electrical signals obtained that are as precise as possible, it is advantageous if the calculated characteristic properties of the transfer function are stored and then used for correcting the electrical signals. The time and the location of this correction is not important in this instance.

So as not to limit the dynamic range of the camera through the diffuse light too much, the diffuse light source should preferably be designed relatively weak. Particular consideration has been given to ensure that the diffuse light source is designed for approximately 10% to 20% of the maximum permissible luminance. This results in a corresponding reduction in the accuracy of the detection of the characteristic properties of the transfer function, however, so that it is beneficial to average the determined characteristic properties over several measuring cycles of the camera. Because the characteristic properties normally only change very slowly, this is therefore not crucially important. As a rule, the characteristic properties have merely an undesirable temperature dependence, wherein the temperature varies significantly within a range of several seconds, at most. In addition, this averaging has the advantage that the imaging signals to be measured average out during the difference calculation. In this way, the characteristic properties of the transfer function can be determined without suppression of the image signals to be measured. This reduces the complexity in the structural design of the camera, since particularly no aperture is required.

In order to achieve as simple an application as possible, it is advantageous if the characteristic properties of the transfer function from the electrical signals of the photoelectric converters is calculated with and without diffuse illumination. Thus only one pre-defined luminance must be adjusted for the diffuse light source.

Alternatively or in addition, it is beneficial if the characteristic properties of the transfer function from the electrical signals of the photoelectric converters are calculated with different luminance of different diffuse luminance, however. Although this results in increased circuit complexity, this provides more information of the transfer function, however, which can therefore be corrected more easily.

The camera as taught by the invention comprises photoelectric converters which convert incident light with transfer functions into electrical signals. Since these transfer functions are normally different from converter to converter, the invention provides that at least one characteristic property of these transfer functions can be metrologically detected. For this purpose, the camera comprises at least one diffuse light source, whose light can be applied at least to a part of the photoelectric converters. In this manner, the luminance received by the photoelectric converters can be elevated in a defined manner. From the individual elevation of the electrical signals of the individual converters resulting herefrom, the characteristic property of the transfer function of the electrical converters is calculated in at least one data processor.

If this characteristic property is known, the variation of the transfer function from converter to converter can at least be partially mathematically eliminated, which makes the camera more suitable for metrological applications.

It is advantageous, if the diffuse light source is coupled between the photoelectric converters and the camera lens. The concrete position of the diffuse light source is basically insignificant in this instance, since the light of the light source can be transmitted by means of optical guides, mirror or prism systems to the desired position, for example. Injecting the diffuse light between the camera lens and the photoelectric converter results in a diffuse illumination of the photoelectric converters, so that these are particularly evenly illuminated with the diffuse light source. In this way, particularly the photoelectric converters can be especially precisely attuned to each other. If the luminance of the diffuse light source is also known, the camera can then be calibrated in absolute photometric units. In this manner, it is eminently suited for metrological applications.

Depending on the design of the light source, it is advantageous if at least one diffusion disk is assigned to it. In this manner, the illumination of the photoelectric converters can be homogenized.

It is particularly beneficial for measuring purposes, if the data processor has an active connection to storage means. These storage means store the calculated characteristic properties of the transfer functions in order to correct the measured electrical signals of the photoelectric converters with these stored values. Preferably, as many characteristic properties of the transfer functions are determined so that the overall transfer function is known in order to calculate the exact luminance and output it from each measured electrical signal.

In principle, it is sufficient if the light of the diffuse light source is added to the normal camera image. The camera image is essentially eliminated during the calculation of the characteristic properties of the transfer functions, preferably through subtraction of the electrical signals of the photoelectric converters, with and without diffuse illumination. This is completely sufficient for camera images that change gradually. In the case of camera images which are subject to rapid cyclic variation, the camera image can be eliminated by appropriate averaging. In all other cases as well as for increasing the measuring accuracy, according to claim 11 it is beneficial, however, if at least one shutter is assigned to the camera lens. This shutter blocks the camera image which is mapped by the camera lens, starting from the photoelectric converters, so that these exclusively capture the diffuse light source. In this manner, a particularly exact determination of the transfer functions results. A disadvantage here is the increased structural complexity as well as the time needed for activating the shutter, however.

The latter can be reduced by use of a shutter with a liquid crystal mechanism, for example.

Further advantages and features of the present invention are explained in the following detailed description, using the associated FIGURE, which contains an embodiment of the present invention. It is to be understood, however, that the drawing serves only as a representation of the invention and does not limit the protective scope of the invention.

The only FIGURE shows a schematic representation of a camera 1 with a body 2. This body 2 holds a camera lens 3, which can be axially shifted by means of a thread 4. In this manner, the axial position of the camera lens 3 can be adjusted for focusing. Alternatively, consideration was also given to shift the camera motorized on a sliding carriage in order to realize an autofocusing device.

In addition, a CCD chip 5 is provided in the body 2, which comprises a series of photoelectric converters 6. These photoelectric converters 6 are in the form of a matrix array in the illustrated embodiment, where also a linear array is conceivable. In the latter case, either the object to be viewed is moved or its image is coupled into the camera lens 3 by means of a rotating mirror or prism, in this instance.

Outside of the camera 2, an optically capturable object 7 is provided, which emits light 8 in the direction of the camera 1. This light 8 is mapped by the camera lens 3 on the photoelectric converters 6 of the CCD chip 5. Thus the photoelectric converters 6 capture a pixel image of the object 7. This pixel image is generated in the form of electrical signals and is serially output by means of a charge-coupled circuit to a pin 9 of the CCD chip 5.

In this instance, each photoelectric converter 6 of the CCD chip 5 has its own individual transfer function with which it converts the incident luminance into an electrical signal. The variances of this transfer function from each other are reflected in image inaccuracies which can arbitrarily vary statistically from pixel to pixel of the image. In order to compensate for these inaccuracies, a diffuse light source 10 in the form of an LED is incorporated in the camera body 2. A diffusion disk 11 is subordinated to this diffuse light source 10 to improve the diffusivity of this light. For this purpose, the coupling location of the diffuse light source 10 is between the camera lens 3 and the CCD chip 5 so that uniform illumination of the photoelectric converters 6 can be assured.

The electrical signals which are uncoupled on pin 9 of the CCD chip 5 are supplied to a data processor 12, which is preferably provided in the form of a microprocessor or a microcontroller. In addition, this data processor 12 controls the diffuse light source 10 synchronized to CCD chip 5.

After each image or each field which the CCD chip 5 receives, the diffuse light source 10 is preferably switched on and/or off.

The data processing circuit 12 determines from the electrical signals of the CCD chip 5 a characteristic property of the transfer function of each individual photoelectric converter 6. For this purpose, the data processing circuit 12 forms the difference between the electrical signals of each individual photoelectric converter 6 on the one hand with, and on the other, without diffuse illumination through the diffuse light source 10. Since the luminance of the diffuse light source 10 is known, the direct result of this difference is the sensitivity of each individual photoelectric converter 6. The only precondition is that a so-called dark adjustment was performed beforehand. This means that the electrical signals can be determined without any light incidence. The so-called dark currents are directly subtracted from the output signals.

Alternatively, the data processing circuit 12 can also work such that the diffuse light source 10 is not only switched on and/or off, but in addition also realizes different luminances. This can be done, for example, by providing multiple diffuse light sources 10 that are operated individually or together. Alternatively, the current can also be varied appropriately through the diffuse light source 10. In this case, a series of measuring points of the electrical signals emitted from the individual photoelectric converters 6 is obtained as a function of the diffuse luminance.

From these values, through the method of minimizing the square of the distance, a fit function can be determined, which not only provide the sensitivity but also the dark signal of the transfer function.

The characteristic properties of the transfer function determined by the data processor 12 are stored in storage means 13. In this way, this measured information can be used for correcting the electrical signals of the photoelectric converters 6. For this purpose, the inverse function of the transfer function of the photoelectric converters is determined so that from the measured electrical signals, the respective applicable luminance can be individually calculated for each photoelectric converter 6. This calculated luminance is output by means of an output 14 and can particularly be used for measuring purposes.

Consideration has also been given to utilizing the data processing circuit 12 in order to filter the determined characteristic properties of the transfer function. In particular, a low-pass filter has been considered in order to obtain floating averaging of this characteristic property in the transfer function.

Between the lens 3 and the diffuse light source 10, a shutter 15 is provided, which can operate both mechanically as well as electrically. This shutter 15 can block the light from the object 7 to be measured in order to improve the detection of the transfer function of the photoelectric converters 6.

In this case, the shutter 15 is then always closed when the electrical signals of the photoelectric converters 6 are utilized for detecting the transfer function.

Since some embodiments of the present invention are not shown and/or described, it is to be understood that a multitude of changes and modifications of this described embodiment are possible without abandoning the essential idea and the protective scope of the invention which is established by the Claims.

### LIST OF REFERENCE SYMBOLS

1 Camera
2 Camera body
3 Camera lens
4 Thread
5 CCD Chip
6 Photoelectric converter
7 Object
8 Light
9 Pin
10 Diffuse light source
11 Diffusion disk
12 Data processor
13 Storage means
14 Output
15 Shutter

1. Method for operating a camera, which through a camera lens receives light that was reflected from an object, where the camera comprises photoelectric converters which convert the incident light with transfer functions into electrical signals and generate a camera image, where diffuse light of different luminance is applied on at least a part of the photoelectric converters, which is superimposed with the reflected light from the object, where through mathematical elimination of those electrical signals which originate from the reflected light from the object from the electrical signals of the photoelectric converters which are superimposed with different diffuse luminance, at least one characteristic property of the transfer functions of each individual photoelectric converter is calculated.

2. Method according to claim 1, where the characteristic property of the transfer functions is a sensitivity, a dark signal and/or a color dependency of each individual photoelectric converter.

3. Method according to claim 1, where the at least one calculated characteristic property of the transfer functions is stored and utilized for correcting the electrical signals.

4. Method according to claim 3, where the characteristic properties are averaged over several measuring cycles of the camera.

5. Method according to claim 1, where the characteristic properties of the transfer functions from the electrical signals of the photoelectric converters are calculated with and without diffuse illumination.

6. Method according to claim 1, where the characteristic properties of the transfer functions from the electrical signals of the photoelectric converters are calculated with different, although different from null, diffuse luminance.

7. Camera with a camera lens, at least one data processor and photoelectric converters, which convert incident light with transfer functions into electrical signals, where opposite from the camera lens an object is mounted, which reflects incident light and maps it through the camera lens onto the photoelectric converters, where the photoelectric converters generate a camera image, and the camera comprises at least one diffuse light source which emits diffused light and applies it on at least part of the photoelectric converters, so that a superimposition of the reflected light from the object, the photoelectric converters can be applied with diffused light on the photoelectric converters, and the photoelectric converters have an active connection with the at least one data processor, which by the elimination of those electrical signals which originate from the light reflected by the object, calculates at least one characteristic property of the transfer function of the photoelectric converters.

8. Camera according to claim 7, where the camera comprises a camera lens, where the at least one diffuse light source is coupled in-between the photoelectric converters and the object lens.

9. Camera according to claim 7, where the diffuse light source has been assigned at least one diffuser disk.

10. Camera according to at least claim 7, where the camera comprises storage means which have an active connection with the data processing unit, which stores the at least one calculated characteristic property of the transfer functions, where the electrical signals of the photoelectric converters are corrected with the stored values for output.

11. Camera according to claim 7, where the camera comprises at least one shutter.
